(19) United States
(12) Patent Application Publication
(10) Pub. No.: US 2011/0013948 A1
(43) Pub. Date: Jan. 20, 2011

(54) CORE MATERIAL OF CARRIER FOR ELECTROPHOTOGRAPHIC DEVELOPER AND METHOD FOR MANUFACTURING THE CORE MATERIAL, CARRIER AND METHOD FOR MANUFACTURING THE CARRIER, AND ELECTROPHOTOGRAPHIC DEVELOPER USING THE CARRIER

(75) Inventors: Koji Aga, Chiba (JP); Issei Shinmura, Chiba (JP); Tetsuya Igarashi, Chiba (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/921,408

(22) PCT Filed: Feb. 27, 2009
(86) PCT No.: PCT/JP2009/053676

§ 371 Date: Sep. 8, 2010

(30) Foreign Application Priority Data
Mar. 31, 2008 (JP) 2008-090669

(51) Int. Cl. G03G 15/08; G03G 9/10; G03G 9/107; G03G 9/113

(52) U.S. Cl. 399/286; 430/111.1; 430/111.3; 430/137.13

(57) ABSTRACT

Objects of the present invention are to provide a carrier core material for an electrophotographic developer having a true spherical shape and excellent strength, and a controllable true density and/or apparent density, and a method for manufacturing the carrier core material, a carrier and a method for manufacturing the carrier, and an electrophotographic developer using the carrier. In order to achieve the objects, there are employed a carrier core material for an electrophotographic developer, containing 3 to 100% by number of hollow particles having an iron content of 36 to 78% by weight, and a carrier for an electrophotographic developer, obtained by coating a resin on a surface of the carrier core material, and methods for manufacturing these, and an electrophotographic developer using the carrier.

### TECHNICAL FIELD

The present invention relates to a core material of a carrier for an electrophotographic developer used for a two-component electrophotographic developer used in copying machines, printers and the like and a method for manufacturing the core material, a carrier and a method for manufacturing the carrier, and an electrophotographic developer using the carrier.

### BACKGROUND ART

The method of electrophotographic development is a method in which toner particles in a developer are made to adhere to electrostatic latent images formed on a photoreceptor to develop the images. The developer used in this method is classified into a two-component developer composed of a toner particle and a carrier particle, and a one-component developer using a toner particle above.

As a development method using a two-component developer composed of a toner particle and a carrier particle among those developers, a cascade method and the like were formerly employed, but a magnetic brush method using a magnet roll is now in the mainstream.

In a two-component developer, a carrier particle is a carrier substance which is agitated with a toner particle in a development box filled with the developer to thereby impart a desired charge to the toner particle, and further transports the charged toner particle to a surface of a photoreceptor to thereby form toner images on the photoreceptor. The carrier particle remaining on a development roll to hold a magnet is again returned from the development roll to the development box, mixed and agitated with a fresh toner particle, and used repeatedly in a certain period.

In a two-component developer, unlike a one-component developer, a carrier particle has functions of being mixed and agitated with a toner particle to charge the toner particle and transporting the toner particle, and has good controllability on designing a developer. Therefore, the two-component developer is suitable for full-color development apparatuses requiring a high image quality, high-speed printing apparatuses requiring reliability and durability in image maintenance, and other apparatuses.

In a two-component developer thus used, it is needed that image characteristics, such as image density, fogging, white spots, gradation and resolving power, exhibit predetermined values from the initial stage, and additionally these characteristics do not vary and are stably maintained during the toner life. In order to stably maintain these characteristics, characteristics of a carrier particle contained in a two-component developer need to be stable.

As a carrier particle forming a two-component developer, an iron powder carrier, such as an iron powder coated on its surface with an oxide film or an iron powder coated on its surface with a resin, has conventionally been used. Since such an iron powder carrier has a high magnetization and also a high conductivity, it has an advantage of easily providing images good in the reproducibility of solid portions.

However, since such an iron powder carrier has a true specific gravity as heavy as about 7.8 and a too high magnetization, agitation and mixing thereof with a toner particle in a development box is liable to generate fusing of toner-constituting components on the iron powder carrier surface, so-called toner spent. Such generation of toner spent reduces an effective carrier surface area, and is liable to decrease the frictional chargeability of a toner particle.

In a resin-coated iron powder carrier, a resin on the surface is peeled off due to stress during the durable period and a core material (iron powder) having a high conductivity and a low dielectric breakdown voltage is exposed, thereby causing the leakage of the charge in some cases. Such leakage of the charge causes the breakage of electrostatic latent images formed on a photoreceptor and the generation of brush streaks on solid portions, thus hardly providing uniform images. For these reasons, the iron powder carrier such as an oxide film-coated iron powder or a resin-coated iron powder has come not to be used recently.

Recently, in place of the iron powder carrier, a ferrite having a true specific gravity as light as about 5.0 and also a low magnetization has been used as a carrier, and further a resin-coated ferrite carrier having a resin coated on its surface has often been used, whereby the developer life has been remarkably prolonged.

A method for manufacturing such a ferrite carrier generally involves mixing ferrite carrier raw materials in predetermined amounts, thereafter calcining and pulverizing the mixture, and granulating and thereafter sintering the resultant. The calcination may be omitted in some cases, depending on the condition.

However, such a method for manufacturing a ferrite carrier has various problems. Specifically, since the sintering step as a step of causing the magnetization by a ferritization reaction generally uses a tunnel kiln, and raw materials are filled in a saggar and sintered, the shape of the ferrite carrier is liable to be deformed due to the influence among the ferrite particles, more remarkably especially in ferrite particles having smaller particle diameters, and after the sintering, the ferrite particles turn into blocks and generate cracks and chips on disintegration thereof, resulting in mingling of deformed particles. Moreover, in the case of manufacturing a ferrite particle having a small particle diameter, a ferrite particle having a good shape cannot be provided without intensified crushing. There is further a problem that the sintering time, if including the temperature-raising time, the maximum temperature-holding time and the temperature-descending time, needs about 12 hours, and the particles having turned into blocks after the sintering need to be disintegrated, resulting in poor production stability.

Further, since a carrier core material manufactured by such a sintering method has not only cracked and chipped particles but also many deformed particles, even if a resin film is formed, a uniform film is difficult to form. The resin film becomes thick on recessed portions of the particle surface, and becomes thin on projected portions thereof. The portions having a thin resin film exhibit early exposure of the carrier core material due to stress, and causes the leakage phenomenon and the broadening of the charge amount distribution, thereby making the long-term stabilization of high-quality images difficult.

In order to prevent cracking and chipping and reduce the member of deformed particles, the aggregation of particles on sintering needs to be prevented; and sintering at a rather low temperature therefor makes disintegration stress after sintering low, which can reduce the member of cracked and chipped particles, deformed particles and the like.

However, in this case, the surface of the particles become porous, and the rising-up of charging becomes worse due to the infiltration of a resin and the like; and the resin amount in unnecessarily infiltrated portions becomes large, which is economically inferior; thus, this case is not preferable from both viewpoints of quality and cost.

In order to solve such problems, new methods for manufacturing a ferrite carrier are proposed. For example, Patent Document 1 (Japanese Patent Laid-Open No. 62-50839) describes a method for manufacturing a ferrite carrier in which a blend comprising metal oxides blended as raw materials for forming the ferrite is passed through a high-temperature flame atmosphere to thereby instantaneously ferritize the blend.

However, this manufacturing method is carried out in a ratio of the oxygen amount/the combustion gas amount of 3 or less, which makes the sintering difficult depending on ferrite raw materials. Further, the method is not suitable for manufacture of a ferrite having a small particle diameter, for example, about 20 to 50 μm, meeting the recent years' particle diameter reduction of carriers, and cannot provide spherical uniform ferrite particles.

Patent Document 2 (WO 2007-63933) describes a method for manufacturing a resin-coated ferrite carrier, using a thermal spray method like the above, using a combustion gas and oxygen as a combustible gas combustion flame, and setting a volume ratio of the combustion gas and oxygen at 1:3.5 to 6.0, and contends that the resin-coated ferrite carrier thus manufactured has a carrier core material surface provided with an unevenness being a fine-streaky wrinkled pattern, serving to improve the adhesive strength with the resin film.

As described in Patent Document 2, true spherical particles produced by the conventional thermal spray method have a feature of exhibiting a good fluidity, but the method can produce only particles having a high apparent density. Hence, even if the fluidity is good, if the agitating stress is strong, there is an apprehension that a toner is broken in a development apparatus.

On the other hand, Patent Document 3 (Japanese Patent Laid-Open No. 7-237923) describes a ferrite-containing hollow particle. The hollow particle is obtained without a thermal treatment such as sintering, but hollow particles of several to several tens of micrometers cannot be obtained. Further, the document contends that its application is, for example, a use as a carbon dioxide-fixing catalyst obtained by wash coating the hollow particle on a honeycomb carrier having a monolithic structure, and drying the coated carrier, and as required, sintering it, and thus the hollow particle cannot be used as a carrier core material for an electrophotographic developer.

Patent Document 4 (Japanese Patent Laid-Open No. 2005-29437) describes a method for manufacturing a ferrite hollow particle, in which a fine powder to become a ferrite raw material is coated on an acrylic resin particle to disappear on sintering, and the coated particle is regularly sintered to obtain the hollow ferrite particle, but the method essentially needs an acrylic resin to form the hollow. Since the sintering is a sintering in a common electric furnace, there is an apprehension that the particles coalesce, fuse or otherwise on sintering. Further, an electromagnetic wave shielding material is cited as an application thereof, but the hollow ferrite particle is not one used for a carrier core material for an electrophotographic developer.

Patent Document 5 (Japanese Patent Laid-Open No. 2007-34249) describes a carrier core material for an electrophotographic developer having a hollow structure, which has an apparent density of 2.0 g/cm³ or lower and whose apparent density/true density is in a certain range. Patent Document 5 describes the formation of pores in particles before sintering by making carbon dioxide gas, steam and the like generated during calcination. The document intends to achieve a low specific gravity by addition of a silica powder having a low specific gravity. By the method of controlling the apparent density and/or the true specific gravity by forming pores in such a way, it is very difficult to obtain a spherical smooth surface. Although use of an additive having a low specific gravity allows control of the apparent density and the true specific gravity, since the additive is present in the interior and on the surface of the particle, there arises an apprehension that the additive influences characteristics of the particle. Particularly, the chargeability of a negatively charging toner by the particle manufactured by the method disclosed in Patent Document 5 is remarkably bad due to negative chargeability of the silica contained therein.

Patent Documents 3 to 5 cited above disclose hollow particles, but methods disclosed therein need the previous addition of a substance to form hollows, causing a problem that the substance is liable to remain depending on the sintering condition. The each hollow particle further has problems as described above.

### Patent Document 1: Japanese Patent Laid-Open No. 62-50839

### Patent Document 2: WO 2007-63933

### Patent Document 3: Japanese Patent Laid-Open No. 7-237923

### Patent Document 4: Japanese Patent Laid-Open No. 2005-29437

### Patent Document 5: Japanese Patent Laid-Open No. 2007-34249

The carrier core material for an electrophotographic developer is desirably of a true spherical shape and excellent in strength. A carrier core material is demanded in which the true density and/or the apparent density can be controlled with the true spherical shape retained, and when such a carrier core material is coated on its surface with a resin and used as a carrier in combination with a toner to form a developer, the carrier can reduce the stress to the toner during agitation of the carrier with the toner in a development apparatus.

### DISCLOSURE OF THE INVENTION

### Problems to be Solved by the Invention

Therefore, objects of the present invention are to provide a carrier core material for an electrophotographic developer, which has a true spherical shape and an excellent strength, and whose true density and/or apparent density can be controlled, and a method for manufacturing the carrier core material, and a carrier and a method for manufacturing the carrier, and an electrophotographic developer using the carrier.

### Means for Solving the Problems

As a result of exhaustive studies to solve the problems as described above, the present inventors have found that the above objects can be achieved by a carrier core material having hollow particles in a certain range or more, and such a carrier core material can be manufactured by a thermal spray method. This finding has led to the present invention.

That is, the present invention is to provide a carrier core material for an electrophotographic developer, the material comprising 3 to 10% by number of a hollow particle having an iron content of 36 to 78% by weight.

The carrier core material for an electrophotographic developer according to the present invention desirably has an average particle diameter of 20 to 150 μm.

The carrier core material for an electrophotographic developer according to the present invention desirably has a true specific gravity of 2.5 to 4.75 g/cm³.

The carrier core material for an electrophotographic developer according to the present invention desirably has an apparent density of 1.5 to 2.6 g/cm².

The carrier core material for an electrophotographic developer according to the present invention desirably has a magnetization of 5 to 95 Am²/kg (emu/g).

The carrier core material for an electrophotographic developer according to the present invention desirably satisfies 0.10<d₂/d₁<0.90 where d₁ represents the outer diameter (average particle diameter) of the core material and d₂ represents the outer diameter of a hollow portion present inside the core material.

The present invention is to provide a carrier for an electrophotographic developer, comprising the carrier core material coated on a surface thereof with a resin.

The present invention is to provide a method for manufacturing a carrier core material for an electrophotographic developer, comprising thermally spraying, in the air a granulated material prepared from raw materials of the carrier core material and a binder to ferritize the granulated material, and then quenching and solidifying the ferritized material.

In the method for manufacturing a carrier core material for an electrophotographic developer according to the present invention, the granulated material desirably has an apparent density of 0.4 to 1.0 g/cm³.

In the method for manufacturing a carrier core material for an electrophotographic developer according to the present invention, an iron component raw material as a raw material of the carrier core material is desirably FeOOH.

In the method for manufacturing a carrier core material for an electrophotographic developer according to the present invention, the granulated material desirably has a binder content of 0.8 to 3.5% by weight in terms of solid content.

The present invention is to provide a method for manufacturing a carrier for an electrophotographic developer, the method comprising coating a resin on a surface of the carrier core material obtained by the method for manufacturing a carrier core material for an electrophotographic developer.

The present invention is to provide an electrophotographic developer comprising the carrier and a toner.

### ADVANTAGES OF THE INVENTION

The carrier core material for an electrophotographic developer and the carrier according to the present invention have a true spherical shape and an excellent strength, and the true density and/or the apparent density thereof can be controlled. Further, the manufacturing method according to the present invention can suitably produce the carrier core material and the carrier. An electrophotographic developer using the carrier can reduce the stress on a toner during agitation with the toner in a development apparatus.

### BEST MODE FOR CARRYING OUT THE INVENTION

Hereinafter, the best mode to embody the present invention will be described.

### <Carrier Core Material for an Electrophotographic Developer According to the Present Invention>

The carrier core material for an electrophotographic developer according to the present invention comprises 3 to 100% by number, preferably 3 to 60% by number and more preferably 3 to 40% by number of a hollow particle having an iron content of 36 to 78% by weight. The case where the iron content is less than 36% by weight means that the iron is not a main component. The iron content cannot be higher than 78% by weight because an iron oxide containing the largest amount of iron is FeO. when the hollow particles account for less than 3% by number, the core material does not differ from usual core material particles containing no hollow particle, not providing the advantage of the present invention. The proportion of hollow particles is determined as the number of hollow particles contained in one visual field/the number of all particles contained in the one visual field by photographing the cross-sections of the core material particles by SEM at a magnitude of 200 times. The content of Fe and the contents of Mg and Ti described later were measured as follows.

### (Contents of Fe, Mg and Ti)

0.2 g of a carrier core material was weighed; the carrier core material was added to a solution in which 20 ml of hydrochloric acid at 1 mol/l and 20 ml of nitric acid at 1 mol/l were added to 60 ml of pure water, and heated to prepare an aqueous solution in which the carrier core material was completely dissolved; and the contents of Fe, Mg and Ti were measured using an ICP analyzer (ICPS-1000IV, made by Shimadzu Corp.).

The carrier core material for an electrophotographic developer according to the present invention desirably has an average particle diameter of 20 to 150 μm, more desirably 20 to 100 μm, and most desirably 25 to 100 μm. A carrier core material having an average particle diameter less than 20 μm is very difficult to produce by the manufacturing method according to the present invention. A carrier using a particle having an average particle diameter larger than 150 μm as a carrier core material for an electrophotographic developer leads to a bad image quality, which is not preferable. The average particle diameter was measured as follows.

### (Average Particle Diameter)

The average particle diameter was measured by a laser diffraction scattering method. A measuring apparatus used was a MicroTrack Particle Size Analyzer (Model: 9320-X100), made by Nikkiso Co., Ltd. The measurement was conducted at a refractive index of 2.42 and under environments of 25±5° C. and a humidity of 55±15%. The average particle diameter (median diameter) used here refers to a cumulative 50% particle diameter in the volume distribution mode and of sieve undersize indication. Dispersion of a carrier sample was carried out by using a 0.2% sodium hexametaphosphate aqueous solution as a dispersion liquid and subjecting the carrier sample to an ultrasonic treatment for 1 min by an Ultrasonic Homogenizer (UH-3C), made by Ultrasonic Engineering Co., Ltd.

The carrier core material for an electrophotographic developer according to the present invention desirably has a true specific gravity of 2.5 to 4.75 g/cm³, more desirably 3.5 to 4.75 g/cm³, and most desirably 3.8 to 4.75 g/cm³. A carrier core material having a true specific gravity higher than 4.75 g/cm³ does not differ from usual core material particles, not providing the advantage of the present invention. In the case where the true specific gravity is lower than 2.5 g/cm³, even if hollow particles are produced, since the strength of the particles is inferior, the particles cannot be used as a carrier core material for an electrophotographic developer. The true specific gravity was measured as follows.

### (True Specific Gravity)

The true specific gravity was measured using a pycnometer according to JIS R9301-2-1. A solvent used was methanol, and the measurement was conducted at a temperature of 25° C.

The carrier core material for an electrophotographic developer according to the present invention desirably has an apparent density of 1.5 to 2.6 g/cm³, more desirably 1.6 to 2.55 g/cm³, and most desirably 1.65 to 2.50 g/cm³. In the case where the apparent density is lower than 1.5 g/cm³, even if hollow particles are produced, since the strength of the particles is inferior, the particles cannot be used as a carrier core material for an electrophotographic developer. A carrier core material having an apparent density higher than 2.6 g/cm³ does not differ from usual core material particles. The apparent density was measured as follows.

### (Apparent Density)

The apparent density was measured according to JIS-Z2504 (Metallic powders—Determination of apparent density—Funnel method).

For the carrier core material for an electrophotographic developer according to the present invention, the specific gravity can be determined using the size of a hollow present inside a particle. The particle surface only has little unevenness but can be always smooth. A particle having a large number of pores has a very weak mechanical strength with no additional treatment given, and in order to use the particle, for example, as a carrier core material for an electrophotographic developer, it is essential to subject the particle to a treatment such as filling a large amount of a resin, but the hollow particle according to the present invention has an outer hard shell like an egg, and can assume a high-strength structure.

Depending on the sintering condition, the hollow portion present inside a particle and the outer side of the particle may be linked with pores without degrading the strength of the particle and in the state of not so much unevenness of the particle surface. Therefore, the apparent density may be controlled with the true specific gravity retained similarly to usual ferrite particles. Even if the hollow portion and the particle outer side are linked, not only the apparent density of a particle but also the true specific gravity thereof may be controlled by clogging the pores in the vicinity of the surface with a resin or the like.

The carrier core material for an electrophotographic developer according to the present invention desirably has a magnetization of 5 to 95 Am²/kg (emu/g) at 5K·1000/4π·A/m. Since the material contains iron as a main component and its magnetization does not exceed that of magnetite, the magnetization can never exceed 95 Am²/kg. When the magnetization is less than 5 Am²/kg (emu/g), there is a possibility that heat is not fully conducted to the particle and it means that the particle is insufficient in strength to be used in the electrophotographic application, which is not preferable. The magnetization is measured as follows.

### (Magnetization)

The measurement of the magnetization used a vibrating sample-type magnetometer (model name: VSM-C7-10A, made by Toei Industry Co., Ltd.). A measurement sample was filled in a cell of 5 mm in inner diameter and 2 mm in height, and placed on the magnetometer. The measurement was conducted by sweeping an applied magnetic field to the maximum of 5K·1000/4π·A/m (5 kOe). Then, the applied magnetic field was reduced and a hysteresis curve was prepared on a recording paper. The magnetization was determined from the curve.

The carrier core material for an electrophotographic developer according to the present invention desirably comprises 12% by weight or less of Mg and/or 12% by weight or less of Ti. In the case where Mg is more than 12% by weight, since Mg is not incorporated as ferrite, Mg remains on the particle surface and/or inside the particle as MgO, which reacts with moisture and carbon dioxide gas in the air to make Mg(OH)₂ and MgCO₃, deteriorating the environmental dependency. In the case where Ti is more than 12% by weight, since TiO₂ is not converted to Fe₂TiO₅ and/or FeTiO₃ and TiO₂ only is present on the particle surface and/or inside the particle, which causes the deterioration of charge properties of a negatively charging toner, which is not preferable. The contents of Mg and Ti were measured by the method described above.

The carrier core material for an electrophotographic developer according to the present invention desirably satisfies 0.1<d₂/d₁<0.9, more desirably 0.1<d₂/d₁<0.8, and most desirably 0.1<d₂/d₁<0.65, where d₁ represents the outer diameter of a core material and d₂ represents the outer diameter of a hollow portion present inside the core material. When the d₂/d₁ is 0.10 or less, the core material has a small hollow portion and does not differ from usual core material particles. When the d₂/d₁ is 0.90 or more, even if hollow particles are produced, since the strength of the particles is inferior, the particles cannot be used as a carrier core material for an electrophotographic developer. The d₁ and the d₂ are determined by the measurement by SEM photographs of particle cross-sections. Here, since a central part (maximum-diameter part) of a core material particle cannot always be observed as a cross-section thereof, and there is a possibility of observation of a portion deviated from the central part, precautions should be taken. Additionally, Since a hollow portion is not always produced at the central part of a core material particle, precautions should be taken when the hollow portion is observed at a position deviated from the central part and/or two or more hollow portions are produced. The outer diameters were measured specifically as follows.

(The Outer Diameter d₁ of a Core Material, and the Outer Diameter d₂ of a Hollow Portion)

With respect to the particle cross-section, a carrier core material was buried in an epoxide resin; thereafter, the resin was cured such that the carrier core material was fixed with the carrier core material dispersed in the resin; then the resin composition in which the carrier core material had been buried was ground on a rotary grinder to fabricate a sample for photographing the cross-section of the carrier core material by SEM. The fabricated sample for photographing was photographed using SEM (JSM-6060A, made by JEOL Ltd.) at a reasonable magnification for a plurality of visual fields so that the number of sampled particles became 200 to 300; and the images obtained were measured for the outer diameters (maximum diameters) of core material particles and, in the case where hollow portions are present inside the core material, also the outer diameters (maximum diameters) of hollow portions, using the length-measurement mode of an image viewer software (SmileView), made by JEOL Ltd., to obtain respective averages, which were denoted as the outer diameter (maximum diameter) d₁ of the core material particle and the outer diameter (maximum diameter) d₂ of the hollow portion.

The carrier core material for an electrophotographic developer according to the present invention has a shape factor SF-1 of 100 to 120. In the case of using the thermal spray method, the shape factor SF-1 never exceeds 120. The shape factor SF-1 was measured as follows.

### (Shape Factor SF-1)

Carrier particles were dispersed so as not to overlap each other and photographed for 450X visual fields using SEM, JSM-6060A, made by JEOL Ltd. at an acceleration voltage of 20 kV; the image information was introduced to an image analysis software (Image-Pro PLUS), made by Media Cybernetics Inc. through an interface, and analyzed to determine an Area and a Feret diameter (maximum); and the shape factor SF-1 was calculated from these values by the equation described below. The shape factor SF-1 of a carrier having a shape nearer to a spherical shape is a value nearer to 100. The shape factor SF-1 was calculated for every one particle, and an averaged value for 100 particles was defined as a shape factor SF-1 of the carrier.

SF−1=(R²/S)×(π/4)×100

R: Feret diameter (maximum), S: Area

The carrier core material for an electrophotographic developer according to the present invention desirably has a specific surface area of 0.065 to 0.65 m²/g, more desirably 0.08 to 0.6 m²/g, and most desirably 0.1 to 0.6 m²/g. The case of the specific surface area less than 0.065 m²/g means a state where there is almost no unevenness of the particle surface, hardly provides the anchor effect of a resin in resin coating, and has a possibility that the coated resin is liable to be peeled off when the carrier core material is used as a developer, causing the charge properties and the resistivity to change, which is not preferable. The case where the specific surface area exceeds 0.65 m²/g means that a hollow portion inside a particle is linked with the outside of the particle through one or more pores, and has a possibility that a coating resin is impregnated in a hollow portion inside a particle in resin coating, and the particle surface cannot be coated with a desired coating amount of the coating resin. The specific surface area was measured as follows.

### (Specific Surface Area)

The specific surface area was measured using a specific surface area analyzer, GEMINI2360, made by Shimadzu Corp. About 10 to 15 g of a measurement sample was placed in a measuring cell, and the weight of the sample was measured precisely using a precision balance; after weighing, the sample was subjected to a vacuum suction heat treatment at 200° C. for 60 min in a gas port attached to the analyzer. Then, the sample was set on a measurement port, and the measurement was started. The measurement was conducted by the 10-points method; the weight of the sample was input at the finish of the measurement, and the BET specific surface area was then automatically calculated.

Measuring cell: a spherical outer shape of 1.9 cm (¾ inch), a length of 3.8 cm (1.5 inches), a cell length of 15.5 cm (6.1 inches), a volume of 12.0 cm³, and a sample volume of about 6.00 cm³

Environment: a temperature of 10 to 30° C., a relative humidity of 20 to 80%, and no dew condensation

The carrier core material for an electrophotographic developer according to the present invention desirably has a surface having been subjected to an oxidation treatment. The thickness of an oxide film formed by the oxidation treatment is preferably 0.1 nm to 5 μm. With the thickness less than 0.1 nm, the effect of the oxide film layer is small; and with the thickness exceeding 5 μm, since the magnetization decreases and the resistivity becomes too high, problems such as a decrease in development capability are liable to be generated. Reduction may be carried out before the oxidation treatment, as required.

### <The Carrier for an Electrophotographic Developer According to the Present Invention>

The carrier for an electrophotographic developer according to the present invention is made by coating a resin on the surface of the above-mentioned carrier core material.

The resin-coated carrier for an electrophotographic developer according to the present invention desirably has a resin film amount of 0.1 to 10% by weight with respect to a carrier core material. With the film amount less than 0.01% by weight, it is difficult to form a uniform film layer on the carrier surface; and with the film amount exceeding 10% by weight, carrier particles aggregate, causing a decrease in the productivity such as a decrease in yield, and variations of developer characteristics such as the fluidity and the charge amount in an actual machine.

A film-forming resin used here can suitably be selected according to a toner to be combined, environments used, and the like. The kind of the resin is not especially limited, but examples of the resins include fluororesins, acrylic resins, epoxy resins, polyamide resins, polyamide imide resins, polyester resins, unsaturated polyester resins, urea resins, melamine resins, alkyd resins, phenol resins, fluoroacrylic resins, acryl-styrene resins, silicone resins, and modified silicone resins modified with a resin such as acrylic resins, polyester resins, epoxy resins, polyamide resins, polyamide imide resins, alkyd resins, urethane resins and fluororesins. In consideration of coming-off of the resin due to the mechanical stress during usage, a thermosetting resin is preferably used. The thermosetting resin specifically includes epoxy resins, phenol resins, silicone resins, unsaturated polyester resins, urea resins, melamine resins, alkyd resins and resins containing them.

In order to control the electric resistivity, the charge amount and the charging rate of a carrier, a conductive agent may be added in a film-forming resin. Since the conductive agent itself has a low electric resistivity, a too much addition amount thereof is liable to cause rapid charge leakage. Therefore, the addition amount is 0.25 to 20.0% by weight, preferably 0.5 to 15.0% by weight, and especially preferably 1.0 to 10.0% by weight, with respect to the solid content of the film-forming resin. The conductive agent includes conductive carbon, oxides such as titanium oxide and tin oxide, and various types of organic conductive agents.

The film-forming resin may comprise a charge control agent. Examples of the charge control agent include various types of charge control agents commonly used for toners, and various types of silane coupling agents. This is because, in the case where the exposed area of a core material is controlled so as to become a relatively small area by the film formation, the charging capability decreases in some cases, but addition of various types of charge control agents and silane coupling agents can control the charging capability. The kinds of charge control agents and coupling agents usable are not especially limited, but charge control agents such as nigrosine dyes, quaternary ammonium salts, organic metal complexes or metal-containing monoazo dyes, and an aminosilane coupling agent, a fluorine-based silane coupling agent or the like are preferably.

### <The Method for Manufacturing a Carrier Core Material for an Electrophotographic Developer and a Carrier According to the Present Invention>

Then, the method for manufacturing a resin-coated carrier for an electrophotographic developer according to the present invention will be described.

The method for manufacturing a carrier core material for an electrophotographic developer according to the present invention comprises thermally spraying and ferritizing, in the air, a granulated material obtained by preparing raw materials for a carrier core material with a binder, and then quenching and solidifying the ferritized material to obtain a carrier core material.

The method for preparing a granulated material using raw materials for a carrier core material is not especially limited, and a conventionally well-known method can be employed. A dry method or a wet method may be used.

In order to obtain a reasonably hollow particle, the above-mentioned granulated material desirably has an apparent density of 0.4 to 1.0 g/cm³. With the apparent density less than 0.4 g/cm³, the hollow portion may become too large and there is a possibility that the particle is liable to break. With the apparent density more than 1.0 g/cm³, there is a possibility that a sufficient hollow portion cannot be formed, not providing a hollow particle. The apparent density was measured by the method described above.

In the manufacturing method according to the present invention, FeOOH is desirably used as an iron component raw material of raw materials for a carrier core material. Since FeOOH exhibits a large volume change, a desired hollow particle can be obtained. By contrast, since Fe₂O₃ and Fe₃O₄ exhibit a smaller volume change than FeOOH, there is a high possibility that a hollow particle cannot be obtained.

In order to enable a hollow particle to be produced, it is necessary to use raw materials exhibiting a large volume change on sintering to expand the particle on sintering and generate a gas such as carbon dioxide gas and/or steam in such a degree that a hollow state can be maintained even after sintering. A raw material exhibiting a large volume change mentioned here refers to one having a high degree of contraction of the raw material particle itself by sintering and/or one contracting due to a large change in the crystal structure on sintering. From this point, FeOOH (goethite and/or lepidcrocite) is best suited as an iron raw material of raw materials for a carrier core material.

The content of a binder used with the carrier raw materials is desirably 0.8 to 3.5% by weight in terms of solid content in the above-mentioned granulated material. Using a binder in such a content can provide a hollow particle. With the content of a binder less than 0.8% by weight in terms of solid content, since a gas to form and maintain a hollow portion on thermal spraying is not sufficiently generated, it is difficult to obtain a hollow particle; and with the content exceeding 3.5% by weight, since a gas to form and maintain a hollow portion on thermal spraying is excessively generated, a hollow portion becomes too large and the particle is broken and thus a hollow particle is hardly provided. The binder used here is polyvinyl alcohol (PVA), polyvinylpyrrolidone (PVP), or the like.

An example of a preparation method of a granulated material will be described. Raw materials in suitable amounts are weighed, water is added thereto the mixture is pulverized to prepare a slurry, the prepared slurry is granulated by a spray drier, and the granulated material is classified to prepare a granulated material having a predetermined particle diameter. The granulated material preferably has a particle diameter of about 20 to 50 μm in consideration of the particle diameter of an obtained carrier. In another example, weighing raw materials in suitable amounts are weighed, then mixed and subjected to dry pulverizing to pulverize and disperse each of the raw materials, the mixture is granulated by a granulator, and the granulated material is classified to prepare a granulated material having a predetermined particle diameter.

The granulated material thus prepared is thermally sprayed in the air. For the thermal spray, a combustion gas and oxygen are used as a combustible gas combustion flame, and the volume ratio of the combustion gas and oxygen is 1:3.5 to 6.0. When the proportion of oxygen in a combustible gas combustion flame is less than 3.5 with respect to the combustion gas, melting is not sufficient; and when the proportion of oxygen exceeds 6.0 with respect to the combustion gas, ferritization becomes difficult. Oxygen is used in a proportion of, for example, 35 to 60 Nm³/hr with respect to 10 Nm³/hr of the combustion gas.

The combustion gas used for the thermal spray is propane gas, propylene gas, acetylene gas, or the like, but especially propane gas is suitably used. As a granulated material conveying gas, nitrogen, oxygen or air is used. The flow rate of a granulated material is preferably 20 to 60 m/sec.

Herein, desirably, the flame temperature of a burner used in thermal spray is 1,500 to 3,000° C. and the flame-passing time is within 10 sec.

In order to maintain a hollow state of a particle, a force is needed which is balanced with a surface tension generated on the particle surface on sintering, or is in such a degree that the particle is not allowed to contract, but since a source for generating evolve a gas inside the particle is limited, the sintering needs to be completed in a short time, and the thermal spray is best suited as the sintering method.

As the kind of gases to be generated, carbon dioxide gas and/or steam is best suited because having no influence on facilities and workers, and sources for generating carbon dioxide include carbon dioxide and moisture contained in raw materials and/or additives such as a binder and the like. Therefore, various types of carbonate salts, oxide hydrates and/or hydroxides are best suited as raw materials. As additives, a binder and the like are preferably used.

When a small amount of a gas is generated, the expansion force is in sufficient and the surface tension surpasses so that, no hollow particle can be produced. When a too much amount of a gas in generated, the particle comes to burst, resulting in producing only a particle which is finer than a target particle and is not hollow.

The particle thus obtained by thermal spray is charged in the air or water to quench and solidify the particle.

Thereafter, the solidified particle is recovered, dried and classified to obtain a carrier core material. As a classification method, an existing air classification, mesh filtration method, precipitation method or the like is used to regulate the dried particle to a desired particle diameter. In the case where the recovery is carried out in a dry system, the recovery may be carried out using a cyclone or the like.

Although the carrier core material for an electrophotographic developer thus manufactured has pores present in the surface, since the increase in the specific surface area can be suppressed to the minimum unlike a particle having a large number of pores produced by decreasing a usual sintering temperature, the carrier core material can also exhibit the environmental dependency suppressed to the minimum.

Thereafter, as required, the surface may be heated at a low temperature to be subjected to an oxide-film formation to regulate the electric resistivity. The oxide-film formation involves a heat treatment, for example, at 300 to 700° C. using a common rotary electric furnace, batch-type electric furnace or the like.

The carrier for an electrophotographic developer according to the present invention is obtained by coating an above-mentioned resin on the surface of the carrier core material to form a resin film thereon. As a coating method, there is a well-known method, for example, a brush coating method, a spray dry system using a fluidized bed, a rotary dry system, and a dip-and-dry method using a universal agitator, and the coating can be carried out by the one method. In order to improve the surface coverage, the method using a fluidized bed is preferable.

When the resin is baked after a resin is coated on the carrier core material, the baking may be carried out using either of an external heating system and an internal heating system, for example, a fixed or fluidized electric furnace, a rotary electric furnace, a burner furnace and a microwave system. When a UV curing resin is used, a UV heater is used. The baking temperature depends on a resin used, but needs to be a temperature equal to or higher than the melting point or the glass transition point; and for a thermosetting resin, a condensation-crosslinking resin or the like, the temperature needs to be raised to a temperature at which the curing progresses fully.

### <The Electrophotographic Developer According to the Present Invention>

Then, the electrophotographic developer according to the present invention will be described.

The electrophotographic developer according to the present invention comprises the above-mentioned carrier for an electrophotographic developer and a toner.

The toner particle constituting the electrophotographic developer according to the present invention includes a pulverized toner particle manufactured by a pulverizing method and a polymerized toner particle manufactured by a polymerizing method. In the present invention, the toner particles obtained by either of the methods can be used.

The pulverized toner particle can be obtained by sufficiently mixing, for example, a binding resin, a charge control agent and a colorant by a mixer such as a Henschel mixer, then melting and kneading the mixture by a twin-screw extruder or the like, cooling, then pulverizing and classifying the extruded material, and adding external additives to the classified material, and then mixing the mixture by a mixer or the like.

The binding resin constituting the pulverized toner particle is not especially limited, but includes polystyrene, chloropolystyrene, styrene-chlorostyrene copolymers, styrene-acrylate copolymers, styrene-methacrylic acid copolymers, and additionally rosin-modified maleic resins, epoxy resins, polyester resins and polyurethane resins. These are used singly or as a mixture thereof.

The charge control agent usable is an optional one. For example, for a positively chargeable toner, the charge control agent includes nigrosine dyes and quaternary ammonium salts; for a negatively chargeable toner, it includes metal-containing monoazo dyes.

The colorant (coloring agent) usable is a conventionally known dye and pigment. For example, usable are carbon black, phthalocyanine blue, Permanent Red, chrome yellow, phthalocyanine green and the like. Besides, external additives, such as silica powder and titania, to improve the fluidity and aggregation resistance of a toner may be added depending on the toner particle.

The polymerized toner particle is a toner particle manufactured by a well-known method such as a suspension polymerization method, an emulsion polymerization method, an emulsion aggregation method, an ester extension polymerization method or a phase transition emulsion method. Such a polymerized toner particle is obtained, for example, by mixing and agitating a colorant-dispersed liquid in which a colorant is dispersed in water using a surfactant, a polymerizable monomer, a surfactant and a polymerization initiator in an aqueous medium to emulsify and disperse and polymerize the polymerizable monomer in the aqueous medium under agitation and mixing, thereafter adding a salting-out agent to salt out a polymer particle, and filtering, washing and drying the particle obtained by the salting-out. Thereafter, as required, external additives to impart functions may be added to the dried toner particle.

When the polymerized toner particle is manufactured, a fixation improving agent and a charge control agent may be blended in addition to the polymerizable monomer, the surfactant, the polymerization initiator and the colorant, whereby various characteristics of a polymerized toner particle thus obtained can be controlled and improved. In order to improve the dispersibility of the polymerizable monomer in the aqueous medium, and regulate the molecular weight of a polymer obtained, a chain transfer agent may be further used.

The polymerizable monomer used for manufacture of the polymerized toner particle is not especially limited, but examples of the monomers include styrene and its derivatives, ethylenic unsaturated monoolefins such as ethylene and propylene, halogenated vinyls such as vinyl chloride, vinyl esters such as vinyl acetate, and α-methylene aliphatic monocarboxylates such as methyl acrylate, ethyl acrylate, methyl methacrylate, ethyl methacrylate, 2-ethylhexyl methacrylate, acrylic acid dimethyl amino ester and methacrylic acid diethyl amino ester.

Conventionally known dyes and pigments can be used as the colorant (coloring material) in preparation of the polymerized toner particle. For example, usable are carbon black, phthalocyanine blue, Permanent Red, chrome yellow, phthalocyanine green and the like. These colorants may be modified on their surface using a silane coupling agent, a titanium coupling agent or the like.

The surfactant usable in manufacture of the polymerized toner particle is an anionic surfactant, a cationic surfactant, an amphoteric surfactant and a nonionic surfactant.

Here, the anionic surfactant includes fatty acid salts such as sodium oleate and castor oil, alkylsulfate esters such as sodium laurylsulfate and ammonium laurylsulfate, alkylbenzenesulfonate salts such as sodium dodecylbenzenesulfonate, alkylnaphthalenesulfonates, alkylphosphate salts, naphthalenesulfonic acid-formalin condensates and polyoxyethylene alkylsulfate salts. The nonionic surfactant includes polyoxyethylene alkyl ethers, polyoxyethylene fatty acid esters, sorbitan fatty acid esters, polyoxyethylene alkylamines, glycerol, fatty acid esters and oxyethylene-oxypropylene block polymers. Furthermore, the cationic surfactant includes alkylamine salts such as laurylamine acetate, and quaternary ammonium salts such as lauryltrimethylammonium chloride and stearyltrimethylammonium chloride. Then, the amphoteric surfactant includes aminocarboxylate salts and alkylamino acids.

A surfactant as described above can be used usually in an amount in the range of 0.01 to 10% by weight with respect to a polymerizable monomer. Such a surfactant influences the dispersion stability of a monomer, and influences also the environmental dependency of a polymerized toner particle obtained. The use of the surfactant in the range described above is preferable from the viewpoint of securing the dispersion stability of the monomer and reducing the environmental dependency of the polymerized toner particle.

For manufacture of a polymerized toner particle, a polymerization initiator is usually used. The polymerization initiator includes a water-soluble polymerization initiator and an oil-soluble polymerization initiator. In the present invention, either of them can be used. Examples of the water-soluble polymerization initiators usable in the present invention include persulfate salts such as potassium persulfate and ammonium persulfate, and water-soluble peroxide compounds. Examples of the oil-soluble polymerization initiators include azo compounds such as azobisisobutyronitrile, and oil-soluble peroxide compounds.

When a chain transfer agent in the present invention is used, examples of the chain transfer agents include mercaptans such as octylmercaptan, dodecylmercaptan and tert-dodecylmercaptan, and carbon tetrabromide.

When a polymerized toner particle used in the present invention comprises a fixability improving agent, the fixability improving agent usable is natural waxes such as carnauba wax, and olefinic waxes such as polypropylene and polyethylene.

When the polymerized toner particle used in the present invention comprises a charge control agent, the charge control agent used is not especially limited, and usable are nigrosine dyes, quaternary ammonium salts, organic metal complexes, metal-containing monoazo dyes, and the like.

External additives used for improving the fluidity and the like of a polymerized toner particle include silica, titanium oxide, barium titanate, fluororesin microparticles and acrylic resin microparticles. These may be used singly or in combination thereof.

The salting-out agent used for separation of a polymerized particle from an aqueous medium includes metal salts such as magnesium sulfate, aluminum sulfate, barium chloride, magnesium chloride, calcium chloride and sodium chloride.

The toner particle manufactured as described above has an average particle diameter in the range of 2 to 15 μm, and preferably 3 to 10 μm, and the polymerized toner particle has a higher uniformity of particles than the pulverized toner particle. If the toner particle is less than 2 μm, the chargeability decreases and fogging and toner scattering are liable to occur; and the toner particle diameter exceeding 15 μm causes the degradation of image quality.

The carrier and the toner manufactured as described above are mixed to obtain an electrophotographic developer. The mixing ratio of the carrier and the toner, that is, the toner concentration is preferably set at 3 to 15%. The toner concentration less than 3% hardly provide a desired image density; and the toner concentration exceeding 15% is liable to generate toner scattering and fogging.

The electrophotographic developer according to the present invention, mixed as described above, can be used in copying machines, printers, FAXs, printing machines and the like, which use a digital system using a development system in which electrostatic latent images formed on a latent image holder having an organic photoconductive layer are reversely developed with a magnetic brush of a two-component developer having a toner and a carrier while a bias electric field is being impressed. The electrophotographic developer is also applicable to full-color machines and the like using an alternative electric field, in which when a development bias is impressed from a magnetic brush to an electrostatic latent image side, an AC bias is superimposed on a DC bias.

Hereinafter, the present invention will be described specifically by way of Examples and the like.

### Example 1

FeOOH was used as a raw material of a carrier core material; water, a binder component and a dispersant were added thereto such that the solid content became 50%; and the mixture was pulverized for 2 hours by a bead mill, and thereafter granulated by a spray drier. The binder used was PVA, and a 10%-PVA aqueous solution was added such that PVA became 1.0% by weight of the whole solid content. The obtained granulated material was passed at a feed rate of 40 kg/hr through a flame to which propane at 5 Nm³/hr and oxygen at 25 Nm³/hr were fed, to obtain a regularly sintered material. The obtained sintered material was classified and magnetically sorted to obtain a carrier core material having an average particle diameter of 38.23 μm and containing hollow particles. The feeding of the granulated material to the flame was carried out by an air flow conveyance using nitrogen gas, and the feeding rate of the nitrogen gas flow was set at 11.5 Nm³/hr.

### Example 2

A carrier core material having an average particle diameter of 37.61 μm and containing hollow particles was obtained by the same manner as in Example 1, except that FeOOH and TiO₂ as raw materials of the carrier core material were weighed in a molar ratio of 2 moles and 1 mole, respectively.

### Example 3

A carrier core material having an average particle diameter of 38.45 μm and containing hollow particles was obtained by the same manner as in Example 1, except that FeOOH, Mg(OH)₂ and TiO₂ as raw materials of the carrier core material were weighed in a molar ratio of 16.5 moles, 3.5 moles and 2.5 moles, respectively.

### Example 4

A carrier core material having an average particle diameter of 38.11 μm and containing hollow particles was obtained by the same manner as in Example 1, except that FeOOH, Mg(OH)₂ and TiO₂ as raw materials of the carrier core material were weighed in a molar ratio of 14.5 moles, 3.5 moles and 1.5 moles, respectively.

### Example 5

A carrier core material having an average particle diameter of 37.68 μm and containing hollow particles was obtained by the same manner as in Example 1, except that FeOOH, Mg(OH)₂ and TiO₂ as raw materials of the carrier core material were weighed in a molar ratio of 8.7 moles, 2 moles and 0.5 mole, respectively.

### Example 6

A carrier core material having an average particle diameter of 37.31 μm and containing hollow particles was obtained by the same manner as in Example 1, except that FeOOH, Mg(OH)₂ and TiO₂ as raw materials of the carrier core material were weighed in a molar ratio of 6.7 moles, 1 mole and 0.1 mole, respectively.

### Example 7

A carrier core material having an average particle diameter of 39.13 μm and containing hollow particles was obtained by the same manner as in Example 3, except for altering a Mg raw material of the carrier core material from Mg(OH)₂ to MgCO₃.

### Example 8

A carrier core material having an average particle diameter of 35.01 μm and containing hollow particles was obtained by the same manner as in Example 3, except for altering the feeding amounts of propane and oxygen as a thermal spray condition to 9.5 Nm³/hr and 47.5 Nm³/hr, respectively.

### Example 9

A carrier core material having an average particle diameter of 37.89 μm and containing hollow particles was obtained by the same manner as in Example 3, except for altering the feeding amounts of propane and oxygen as a thermal spray condition to 7 Nm³/hr and 35 Nm³/hr, respectively.

### Example 10

A carrier core material having an average particle diameter of 35.74 μm and containing hollow particles was obtained by the same manner as in Example 3, except for altering the feeding amounts of propane and oxygen as a thermal spray condition to 6 Nm³/hr and 30 Nm³/hr, respectively.

### Example 11

A carrier core material having an average particle diameter of 37.42 μm and containing hollow particles was obtained by the same manner as in Example 3, except for altering the feeding amounts of propane and oxygen as a thermal spray condition to 4 Nm³/hr and 20 Nm³/hr, respectively.

### Example 12

A carrier core material having an average particle diameter of 34.22 μm and containing hollow particles was obtained by the same manner as in Example 3, except for altering the feeding amount of the powder as a thermal spray condition to 30 kg/hr.

### Example 13

A carrier core material having an average particle diameter of 40.38 μm and containing hollow particles was obtained by the same manner as in Example 3, except for altering the feeding amount of the powder as a thermal spray condition to 70 kg/hr.

### Example 14

A carrier core material having an average particle diameter of 97.51 μm and containing hollow particles was obtained by the same manner as in Example 3, except for altering the average particle diameter of the granulated material to 79.88 μm.

### Example 15

A carrier core material having an average particle diameter of 28.22 μm and containing hollow particles was obtained by the same manner as in Example 3, except for altering the average particle diameter of the granulated material to 29.65 μm.

### COMPARATIVE EXAMPLES

### Comparative Example 1

A carrier core material having an average particle diameter of 33.22 μm and containing no hollow particle was obtained by the same manner as in Example 1, except for altering an Fe component raw material as a raw material of the carrier core material from FeOOH to Fe₂O₃.

### Comparative Example 2

A carrier core material having an average particle diameter of 35.34 μm and containing no hollow particle was obtained by the same manner as in Example 1, except for altering an Fe component raw material as a raw material of the carrier core material from FeOOH to Fe₃O₄.

### Comparative Example 3

A carrier core material having an average particle diameter of 9.71 μm and containing no hollow particle was obtained by the same manner as in Example 1, except for altering the amount of the binder to 0.1% by weight.

### Comparative Example 4

A carrier core material having an average particle diameter of 3.41 μm and containing no hollow particle was obtained by the same manner as in Example 1, except for altering the amount of the binder to 5.0% by weight.

### Comparative Example 5

A carrier core material having an average particle diameter of 43.21 μm and containing hollow particles was obtained by the same manner as in Example 1, except for altering the feeding amount of the powder as a thermal spray condition to 100 kg/hr.

### Comparative Example 6

A carrier core material having an average particle diameter of 31.02 μm and containing hollow particles was obtained by the same manner as in Example 1, except for altering the feeding amount of the powder as a thermal spray condition to 5 kg/hr.

The manufacturing conditions (the charging molar number, the forms of Fe and Mg, the amount of a binder, the apparent density and the average particle diameter of a granulated material, and the thermal spray condition) of Examples 1 to 15 and Comparative Examples 1 to 6 are shown in Table 1. Chemical analysis results of the carrier core materials obtained in Examples 1 to 15 and Comparative Examples 1 to 6 are shown in Table 2, and various characteristic values (the true specific gravity, the apparent density, the BET specific surface area, the average particle diameter, the outer diameter d₁ of a core material, the outer diameter d₂ of a hollow portion, the ratio of the outer diameter d₂ of a hollow portion and the outer diameter d₁ of a core material, the proportion of hollow particles, SF-1 and the magnetization) are shown in Table 3. A SEM photograph of a cross-section of a carrier core material particle obtained in Example 8 is shown in FIG. 1.

TABLE 1

| | Proportions of | | | | | | Apparent | Average | Thermal Spray and Sintering Conditions | | | |
|---|---|---|---|---|---|---|---|---|---|---|---|---|
| | Raw Materials | | | | | Amount | Density of | Particle | | | Powder- | |
| | Charged (molar | | | Forms of Raw | | of | Granulated | Diameter of | | | Feeding | Amount of |
| | ratio) | | | Materials | | Binder | Material | Granulated | Propane | Oxygen | Nitrogen | Powder |
| | Fe | Mg | Ti | Fe | Mg | (wt %) | (g/cm³) | Material (μm) | (Nm³/hr) | (Nm³/hr) | (Nm³/hr) | Fed (kg/hr) |
| Example 1 | 1 | 0 | 0 | FeOOH | — | 1 | 0.57 | 45.29 | 5 | 25 | 11.5 | 40 |
| Example 2 | 2 | 0 | 1 | FeOOH | — | 1 | 0.56 | 46.38 | 5 | 25 | 11.5 | 40 |
| Example 3 | 16.5 | 3.5 | 2.5 | FeOOH | Mg(OH)₂ | 1 | 0.57 | 45.21 | 5 | 25 | 11.5 | 40 |
| Example 4 | 14.5 | 3.5 | 1.5 | FeOOH | Mg(OH)₂ | 1 | 0.56 | 45.91 | 5 | 25 | 11.5 | 40 |
| Example 5 | 8.7 | 2 | 0.5 | FeOOH | Mg(OH)₂ | 1 | 0.56 | 43.99 | 5 | 25 | 11.5 | 40 |
| Example 6 | 6.7 | 1 | 0.1 | FeOOH | Mg(OH)₂ | 1 | 0.57 | 43.61 | 5 | 25 | 11.5 | 40 |
| Example 7 | 14.5 | 3.5 | 1.5 | FeOOH | MgCO₃ | 1 | 0.54 | 46.83 | 5 | 25 | 11.5 | 40 |
| Example 8 | 14.5 | 3.5 | 1.5 | FeOOH | Mg(OH)₂ | 1 | 0.55 | 45.03 | 9.5 | 47.5 | 11.5 | 40 |
| Example 9 | 14.5 | 3.5 | 1.5 | FeOOH | Mg(OH)₂ | 1 | 0.55 | 45.44 | 7 | 35 | 11.5 | 40 |
| Example 10 | 14.5 | 3.5 | 1.5 | FeOOH | Mg(OH)₂ | 1 | 0.55 | 44.37 | 6 | 30 | 11.5 | 40 |
| Example 11 | 14.5 | 3.5 | 1.5 | FeOOH | Mg(OH)₂ | 1 | 0.55 | 46.09 | 4 | 20 | 11.5 | 40 |
| Example 12 | 14.5 | 3.5 | 1.5 | FeOOH | Mg(OH)₂ | 1 | 0.55 | 45.71 | 5 | 25 | 11.5 | 30 |
| Example 13 | 14.5 | 3.5 | 1.5 | FeOOH | Mg(OH)₂ | 1 | 0.55 | 45.21 | 5 | 25 | 11.5 | 70 |
| Example 14 | 14.5 | 3.5 | 1.5 | FeOOH | Mg(OH)₂ | 1 | 0.56 | 79.88 | 5 | 25 | 11.5 | 40 |
| Example 15 | 14.5 | 3.5 | 1.5 | FeOOH | Mg(OH)₂ | 1 | 0.56 | 29.65 | 5 | 25 | 11.5 | 40 |
| Comparative | 1 | 0 | 0 | Fe₂O₃ | — | 1 | 0.82 | 44.14 | 5 | 25 | 11.5 | 40 |
| Example 1 | | | | | | | | | | | | |
| Comparative | 1 | 0 | 0 | Fe₃O₄ | — | 1 | 1.02 | 43.28 | 5 | 25 | 11.5 | 40 |
| Example 2 | | | | | | | | | | | | |
| Comparative | 1 | 0 | 0 | FeOOH | — | 0.1 | 0.59 | 45.61 | 5 | 25 | 11.5 | 40 |
| Example 3 | | | | | | | | | | | | |
| Comparative | 1 | 0 | 0 | FeOOH | — | 5 | 0.48 | 45.43 | 5 | 25 | 11.5 | 40 |
| Example 4 | | | | | | | | | | | | |
| Comparative | 1 | 0 | 0 | FeOOH | — | 1 | 0.57 | 45.19 | 5 | 25 | 11.5 | 100 |
| Example 5 | | | | | | | | | | | | |
| Comparative | 14.5 | 3.5 | 1.5 | FeOOH | Mg(OH)₂ | 1 | 0.55 | 44.77 | 5 | 25 | 11.5 | 5 |
| Example 6 | | | | | | | | | | | | |

TABLE 2

| | Chemical Analysis | | |
|---|---|---|---|
| | (wt %) | | |
| | Fe | Mg | Ti |
| Example 1 | 71.38 | — | — |
| Example 2 | 45.97 | — | 19.89 |
| Example 3 | 55.37 | 5.15 | 7.18 |
| Example 4 | 56.01 | 6.44 | 5.48 |
| Example 5 | 58.77 | 6.53 | 3.18 |
| Example 6 | 61.95 | 6.04 | 1.18 |
| Example 7 | 57.03 | 5.99 | 5.09 |
| Example 8 | 57.45 | 6.02 | 5.07 |
| Example 9 | 57.21 | 5.91 | 5 |
| Example 10 | 57.18 | 5.97 | 4.97 |
| Example 11 | 57.3 | 5.94 | 5.03 |
| Example 12 | 57.06 | 6.07 | 4.99 |
| Example 13 | 57.48 | 6.03 | 4.98 |
| Example 14 | 57.33 | 5.98 | 5.05 |
| Example 15 | 57.21 | 5.99 | 5.06 |
| Comparative Example 1 | 72.02 | — | — |
| Comparative Example 2 | 71.81 | — | — |
| Comparative Example 3 | 71.52 | — | — |
| Comparative Example 4 | 71.61 | — | — |
| Comparative Example 5 | 71.77 | — | — |
| Comparative Example 6 | 57.44 | 5.89 | 5.09 |

TABLE 3

| | | | BET | | Outer | Outer | Ratio d₂/d₁ of Outer | | | |
|---|---|---|---|---|---|---|---|---|---|---|
| | True | | Specific | Average | Diameter | Diameter d₂ | Diameter d₂ of | Proportion | | |
| | Specific | Apparent | Surface | Particle | d₁ of Core | of Hollow | Hollow Portion and | of Hollow | Shape | |
| | Gravity | Density | Area | Diameter | Material | Portion | Outer Diameter d₁ of | Particle | Factor | Magnetization |
| | (g/cm³) | (g/cm³) | (m²/kg) | (μm) | (μm) | (μm) | Core Material | (number %) | SF-1 | (Am²/kg) |
| Example 1 | 4.64 | 2.33 | 0.1962 | 38.23 | 34.79 | 14.43 | 0.41 | 12.63 | 105 | 90 |
| Example 2 | 4.62 | 2.16 | 0.287 | 37.61 | 34.23 | 14.46 | 0.42 | 18.98 | 110 | 8 |
| Example 3 | 4.61 | 2.21 | 0.2603 | 38.45 | 34.99 | 12.09 | 0.35 | 17.11 | 108 | 25 |
| Example 4 | 4.62 | 2.11 | 0.3137 | 38.11 | 34.689 | 11.78 | 0.34 | 20.85 | 107 | 34 |
| Example 5 | 4.63 | 2.25 | 0.239 | 37.68 | 34.289 | 12.6 | 0.37 | 15.62 | 106 | 75 |
| Example 6 | 4.66 | 2.12 | 0.2455 | 37.31 | 33.959 | 12.33 | 0.36 | 13.49 | 105 | 53 |
| Example 7 | 4.62 | 2.19 | 0.271 | 39.13 | 35.61 | 12.74 | 0.36 | 17.86 | 107 | 52 |
| Example 8 | 4.68 | 2.49 | 0.1342 | 35.01 | 31.86 | 17.82 | 0.56 | 3.2 | 108 | 53 |
| Example 9 | 4.67 | 2.43 | 0.2133 | 38.79 | 35.3 | 13.75 | 0.39 | 10.2 | 110 | 52 |
| Example 10 | 4.59 | 2.38 | 0.1042 | 35.74 | 32.52 | 12.82 | 0.39 | 15.47 | 106 | 53 |
| Example 11 | 4.62 | 1.72 | 0.5557 | 37.42 | 34.05 | 9.33 | 0.27 | 39.81 | 105 | 53 |
| Example 12 | 4.56 | 2.34 | 0.1909 | 34.22 | 31.14 | 17.85 | 0.57 | 5.71 | 107 | 50 |
| Example 13 | 4.68 | 1.7 | 0.5325 | 40.38 | 36.75 | 9.16 | 0.25 | 36.16 | 108 | 51 |
| Example 14 | 4.62 | 2.46 | 0.1269 | 97.51 | 88.73 | 41.84 | 0.47 | 7.78 | 106 | 52 |
| Example 15 | 4.62 | 2.07 | 0.335 | 28.22 | 25.68 | 8.53 | 0.33 | 22.34 | 109 | 50 |
| Comparative | 5.02 | 2.67 | 0.0548 | 33.21 | 30.22 | — | — | Not present | 105 | 90 |
| Example 1 | | | | | | | | | | |
| Comparative | 4.99 | 2.65 | 0.0624 | 35.34 | 32.16 | — | — | Not present | 107 | 92 |
| Example 2 | | | | | | | | | | |
| Comparative | 4.96 | 1.98 | 0.7231 | 9.71 | 8.84 | — | — | Not present | 106 | 91 |
| Example 3 | | | | | | | | | | |
| Comparative | 4.98 | 1.45 | 1.4321 | 3.75 | 3.41 | — | — | Not present | 108 | 90 |
| Example 4 | | | | | | | | | | |
| Comparative | 4.21 | 1.41 | 0.6873 | 43.21 | 39.32 | 18.08 | 0.46 | 2.88 | 121 | 4 |
| Example 5 | | | | | | | | | | |
| Comparative | 4.89 | 2.61 | 0.0468 | 34.09 | 31.02 | 12.63 | 0.41 | 1.81 | 107 | 53 |
| Example 6 | | | | | | | | | | |

As shown in Table 3, core material particles containing hollow particles could be obtained in Examples 1 to 15, but core material particles containing hollow particles could not be obtained in Comparative Examples 1 and 2 where an iron source was altered to a material not being FeOOH. In Comparative Example 3, since the amount of the binder was too small to generate carbon dioxide and steam enough to maintain a hollow particle in the thermal spray process, core material particles containing hollow particles could not be obtained. In Comparative Example 4, since the amount of the binder was large and the amounts of carbon dioxide and steam produced in the thermal spray process were large, the hollow portion excessively expanded and burst and the broken pieces spheroidized, so core material particles containing hollow particles could not be obtained. In Comparative Example 5, since the feeding rate of the raw materials was too fast to impart sufficient heat in the thermal spray process, although hollow particles were produced, not only the content of the hollow particles was low, but also particles from which only the binder component as a raw material was removed were mingled in a large amount, resulting in particles which could not be used as a carrier core material. In Comparative Example 6, since heat was imparted excessively in the thermal spray process and carbon dioxide and steam escaped from hollow portions of particles in a stretch, although hollow particles were produced, the content thereof was low, resulting in particles not differing from conventional core material particles containing no hollow particles.

### INDUSTRIAL APPLICABILITY

The carrier core material and the carrier for an electrophotographic developer according to the present invention have a true spherical shape and excellent strength, and the true density and/or the apparent density thereof can be controlled. The manufacturing method according to the present invention can produce the carrier core material and the carrier. Suitably an electrophotographic developer using the carrier can reduce the stress against a toner during agitation with the toner in a development apparatus.

Therefore, the present invention can be used broadly especially in the fields of full-color machines requiring high image quality, and high-speed machines requiring the reliability and durability in image maintenance.

### BRIEF DESCRIPTION OF THE DRAWING

FIG. 1 is a SEM photograph of a cross-section of a carrier core material particle obtained in Example 8.

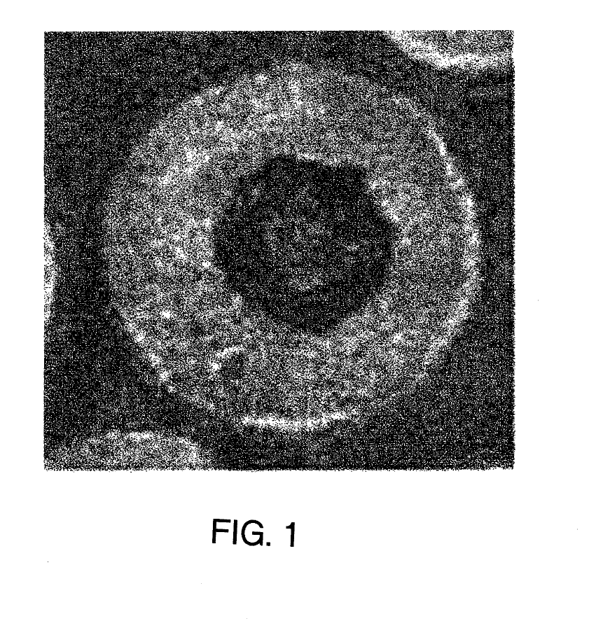

1. A carrier core material for an electrophotographic developer, comprising 3 to 100% by number of a hollow particle having an iron content of 36 to 78% by weight.

2. The carrier core material for an electrophotographic developer according to claim 1, wherein the carrier core material has an average particle diameter of 20 to 150 μm.

3. The carrier core material for an electrophotographic developer according to claim 1, wherein the carrier core material has a true specific gravity of 2.5 to 4.75 g/cm³.

4. The carrier core material for an electrophotographic developer according to claim 1, wherein the carrier core material has an apparent density of 1.5 to 2.6 g/cm³.

5. The carrier core material for an electrophotographic developer according to claim 1, wherein the carrier core material has a magnetization of 5 to 95 Am²/kg (emu/g).

6. The carrier core material for an electrophotographic developer according to claim 1, wherein the carrier core material satisfies 0.10<d₂/d₁<0.90, where d₁ represents an outer diameter (average particle diameter) of the carrier core material and d₂ represents an outer diameter of a hollow portion present inside the carrier core material.

7. A carrier for an electrophotographic developer, comprising a carrier core material according to claim 1 coated on a surface thereof with a resin.

8. A method for manufacturing a carrier core material for an electrophotographic developer, comprising thermally spraying in the air a granulated material prepared from a raw material of the carrier core material and a binder to ferritize the granulated material, and then quenching and solidifying the ferritized material.

9. The method for manufacturing a carrier core material for an electrophotographic developer according to claim 8, wherein the granulated material has an apparent density of 0.4 to 1.0 g/cm³.

10. The method for manufacturing a carrier core material for an electrophotographic developer according to claim 8, wherein an iron component raw material of a raw material of the carrier core material is FeOOH.

11. The method for manufacturing a carrier core material for an electrophotographic developer according to claim 8, wherein the granulated material has a content of the binder of 0.8 to 3.5% by weight in terms of solid content.

12. A method for manufacturing a carrier for an electrophotographic developer, the method comprising coating a resin on a surface of the carrier core material obtained by a manufacturing method according to claim 8.

13. An electrophotographic developer, comprising a carrier according to claim 7 and a toner.
